(19) United States
(12) Patent Application Publication
(10) Pub. No.: US 2015/0099095 A1
(43) Pub. Date: Apr. 9, 2015

(54) COATINGS, COATED SURFACES, AND METHODS FOR PRODUCTION THEREOF

(71) Applicant: AEREUS TECHNOLOGIES INC., Vaughan (CA)

(72) Inventors: Valerian PERSHIN, Mississauga (CA); Thomas PORTMAN, Toronto (CA); Javad MOSTAGHIMI, Mississauga (CA)

(21) Appl. No.: 14/511,726

(22) Filed: Oct. 10, 2014

Related U.S. Application Data
(63) Continuation of application No. PCT/CA2013/050207, filed on Mar. 15, 2013.
(60) Provisional application No. 61/637,538, filed on Apr. 24, 2012.
(60) Provisional application No. 61/703,916, filed on Sep. 21, 2012.

(51) Int. Cl. A01N 25/08; B24B 19/24; C23C 4/18

(52) U.S. Cl. CPC A01N 25/08; C23C 4/18; B24B 19/24
USPC 428/141; 427/455; 451/28; 451/57

(57) ABSTRACT

A substrate having an antimicrobial surface. The texture of the surface which has exposed metal e.g., copper or copper alloy contributes to the antimicrobial properties. Cavities or depressions in the surface can be coated or partially coated with an organic polymer, and the polymer can contain antimicrobial agents. Methods of preparing a coated surface, and uses are described.

### CROSS REFERENCE TO RELATED APPLICATIONS

This application is a continuation application of International Application No. PCT/CA2013/050207, filed Mar. 15, 2013, and claims benefits under 35 USC §119 of U.S. Provisional Application Ser. Nos. 61/637,538 and 61/703,916 filed Apr. 24, 2012 and Sep. 21, 2012, respectively, and the entire disclosures of the referenced applications are incorporated herein by reference.

### FIELD OF THE INVENTION

The present invention relates to a method for producing a substrate with a coating having antimicrobial properties, and articles produced by the method.

### BACKGROUND OF THE INVENTION

Bacterial contamination of surfaces in hospitals, food processing facilities, and restaurants is the underlying cause of many, often life-threatening, microbial infections. It is estimated by the USA's Centers for Disease Control and Food and the Drug Administration that approximately 1/10^{th} of the population becomes ill as a result of infections by enteric pathogens such as Salmonella enterica and Campylobacter jejuni. Another foodborne enteropathogen, Listeria moncytogenes, is fatal in approximately 30 percent of high-risk individuals such as women and newborn children, individuals with weakened immune systems and seniors. Extended periods of hospitalization increase the probability of nosocomial infection with spore-forming antibiotic-resistant strains of Clostridium difficile, a major cause of life-threatening pseudomembranous colitis. The problem is exacerbated by the formation of heat-resistant spores that are refractory to alcohol-based and other disinfectants. Consequently, there has been a great deal of interest in coating surfaces with agents that afford long-term protection against environmentally- and institutionally-derived pathogens.

While organisms require low concentrations of metal cofactors for various metabolic and reproductive processes, high concentrations of ions, such as copper, are biocidal (1). Hence, the coating of surfaces with copper-based alloys could provide a non-toxic, cost effective and ecofriendly way of countering bacterial contaminations. The U.S. Environmental Protection Agency (EPA) has acknowledged the antimicrobial efficacy of over 280 copper-based products against disease-causing bacteria with an average biocidal efficacy of approximately 99% within two hours for alloys containing 60% or higher concentrations of copper (2). On Feb. 29, 2008, the EPA registered five copper-containing alloy products. The registration allows the Copper Development Association (CDA) to market these products with a claim that copper, when used in accordance with the label, “kills 99.9% of bacteria within two hours.” These products will be marketed in sheets that can be fabricated into various articles such as door knobs, counter tops, hand rails, I.V. (intravenous) poles, and other objects found in commercial, residential, and healthcare settings.

The incorporation of copper containing alloys into hospital wards could significantly decreases bacterial contamination compared to stainless steel or polymer surfaces. How copper mediates its potent contact killing of bacteria is context and species dependent. It is well established that copper ions, via Farber and Fenton-mediated reactions, generate highly reactive free radicals (1). Ultrastructural and molecular biology experiments have demonstrated that the plasma membranes of bacteria are compromised in the presence of copper, leading to the release of intracellular components (1, 3). In many cases, genomic and extrachromosomal DNAs are also degraded (1, 3). Whether these activities are mediated by free radical end products with copper ions serving as electron donors/acceptors remains to be determined. The biocidal activity of copper may also be due to the toxic effect of high metal ion concentrations on the biological activity of proteins required for cell survival.

Thermal spray processes are known for coating applications to protect substrates from wear, heat or corrosion. The thermal spray process utilizes energy of an electric arc or combustion to melt and propel material toward a substrate. Upon impact, molten particles spread and solidify, forming a coating (4). A critical feature of the thermal spraying process is the relatively low heat load to the substrate, creating an opportunity to apply copper alloy coatings on heat sensitive surfaces such as wood, engineered medium density fiberboard (MDF) or polymer substrates. The technology provides a cost-effective and rapid method for effectively decreasing bacterial contamination on surfaces. In addition to their esthetic appearance, copper-based alloys have enhanced mechanical and anti-corrosion properties, increasing the longevity of the coated materials/substrates.

### SUMMARY OF THE INVENTION

In one aspect, the invention is a method of providing a substrate with an antimicrobial surface.

The substrate has a metal coat, which may be pre-existing, or may be incorporated onto a substrate surface as part of the method. The metal coat is a sprayed metal coat, and the metal itself can be one with antimicrobial properties.

This approach serves to ameliorate problems associated with such sprayed coats, which, even when manufactured from metals known to have antimicrobial properties, such as copper, provide a surface having a topography prone to gathering dirt and other small particles over time.

It has now been established that it is feasible to treat sprayed metal surfaces as by physical abrasion to produce a surface that is suitably smooth for everyday use and which has the antimicrobial surfaces for which e.g., copper alloy sheet metal components have come to be known.

The invention includes a method of providing a substrate with an antimicrobial surface, the method comprising:

(i) providing a substrate having an outer thermally sprayed metal coat having surface cavities; and

(ii) mechanically abrading the coat to reduce the depth of said cavities.

The texture or roughness of a surface can be defined as “Ra”, the absolute average deviation from the mean line of surface height (or depth) on the sampling length. Where the surface of the outer thermally sprayed metal coat has an initial roughness, Rₐ¹, mechanical abrading is conducted to produce a surface having Rₐ² where Rₐ²<Rₐ¹. Preferably, R₁¹>2Rₐ².

Typically, Rₐ¹ is at least 4 μm, usually between 4 μm and 30 μm.

The abraded surface preferably has a roughness, Rₐ², that is no greater than 6 μm and (Rₐ¹−2)>Rₐ².

It is also preferred that the profile valley depth, Rᵥ, of the surface be reduced by the abrading e.g., the surface of the outer thermally sprayed metal coat has Rᵥ¹ and the surface produced by abrading has Rᵥ², and Rᵥ²<Rᵥ¹. It is particularly preferred that Rᵥ²/Rᵥ¹≦0.8 or 0.7 or 0.6 or 0.5 or 0.4 or 0.3 or 0.2.

The value of Rᵥ² is preferred to be less than or equal to 40 μm, more preferably ≦35 μm, ≦30 μm, ≦25 μm or even ≦20 μm.

Suitable metals are copper and its alloys, such as bronze, brass, combinations thereof.

The coat can be polished subsequent to the step of abrading. Preferably, the abrading step, or the polishing step if applied, is the final step of the method.

In another aspect, a method of the invention can include forming an organic polymer film on the metal coat prior to the abrading step.

“Forming” a polymer film on a metal coat, metal layer, etc. means applying prepolymer mixture, or polymer solution directly to the metal under conditions that result in a film formation on the metal. The film is formed on and is directly adhered or attached to the metal without an intervening layer.

Preferably, the film is formed to a thickness of from 3 to about 20 μm thickness. Other thicknesses are possible, e.g., between 3 and 25 μm, between 3 and 15 μm, between 3 and 10 μm, between 3 and 8 μm, between 4 and 25 μm, between 4 and 20 μm, between 4 and 15 μm, between 4 and 10 μm, between 5 and 20 μm, between 5 and 15 μm, between 5 and 10 μm, or about 3, 4, 5, 6, 7, 8, 9, or 10 μm or greater.

Forming the organic polymer film can include applying to the thermally sprayed metal coat a solution containing polymer molecules or a prepolymer mixture, etc. In a preferred aspect, the solution is a liquid solution and solvent is removed or evaporated.

Forming the organic polymer film typically includes applying the solution and forming the film coat on walls of the cavities of the sprayed metal coat.

In cases where an organic polymer film is applied, the method includes mechanically abrading the film-coated metal to expose underlying metal and produce a surface comprising exposed metal and cavities wherein walls of the cavities are coated by the polymer film.

In the case of setting polymers, the invention can include applying to the coat a prepolymer mixture and curing the prepolymer components.

Utility of an article produced according to a method of the invention can be enhanced by inclusion of one or more biocidal agents as part of the polymer film. Here, a biocide or biocidal agent is a chemical agent, such as an antibacterial substance, antibacterial agent, antimicrobial substance or antimicrobial agent. Biocidal agents include molecules or ions that inhibit, suppress, prevent, eradicate, and/or eliminate, the growth of various microorganisms, such as, for example, but not limited to: bacteria, mould, fungi, viruses, and bacterial or fungal spores. Likely targets of such agents in the context of this invention depend upon the use to which a product having an antimicrobial coating of the invention is to be put. For example, a table top for use in a clinical setting such as a hospital might include one or more agents that act against viral and/or bacterial pathogens.

So, according to the invention the solution containing polymer molecules or the prepolymer mixture can also include one or more biocidal agents.

Examples of biocidal agents are silver ions, copper ions, iron ions, zinc ions, bismuth ions, gold ions, aluminum ions, nanoparticles of heavy metals and oxides such as silver, copper, zinc, metal oxides, metal oxide-halogen adducts such as chlorine or bromine adducts of magnesium oxide, quaternary ammonium compounds such as 2,4,4′-trichloro-2′-hydroxydiphenyl ether, chlorhexidine, triclosan, hydroxyapatite, gentamicin, cephalothin, carbenicillin, amoxicillin, cefamandol, tobramycin, vancomycin, antiviral agents such as quaternary ammonium salts e.g. N,N-dodecyl,methyl-polyethylenimine, antimicrobial peptides, tea tree oil, parabens such as methyl-, ethyl-, butyl-, isobutyl-, isopropyl- and benzyl-paraben, and salts thereof, allylamines, echinocandins, polyene antimycotics, azoles such as imidazoles, triazoles, thiazoles and benzimidazoles, isothiazolinones, imidazolium, sodium silicates, sodium carbonate, sodium bicarbonate, potassium iodide, sulfur, grapefruit seed extract, lemon myrtle, olive leaf extract, patchouli, citronella oil, orange oil, pau d'arco and neem oil.

The polymer film can be an acrylic coating, an epoxy coating, a silicone coating, an alkyd coating, a urethane coating, a polyvinyl fluoride coating, etc.

The invention thus includes products obtained by a method of the invention: an article comprising an antimicrobial surface. The article comprises a substrate having an overlying sprayed metal coat having surface cavities. Surface portions of the metal are exposed and cavities present outwardly. Walls of the cavities are optionally coated with an organic polymer film.

Preferably, roughness of the antimicrobial surface, Rₐ, is no greater than 6 μm, a preferred range being between 2 and 4 μm.

In a preferred aspect, providing a substrate with a metalized surface comprises:

a) providing a source of a jet of molten metal particles having an average temperature within a predetermined range, an average velocity within a predetermined range; and

b) directing said jet of molten metal particles at a surface of a substrate thereby depositing a metal coat on the substrate surface, said source being spaced from the substrate a pre-determined distance, and said average velocity and said average temperature being selected for a given metal such that the temperature of the molten metal particles is very close to the melting point of the metal as the molten droplets coat the surface of the substrate.

In such method, the jet of molten metal particles can be provided by a wire arc spray gun.

Aspects of this are described in United States patent publication No. 2011-0171396 (5) which was published Jul. 14, 2011. The contents of this publication are incorporated herein in their entirety.

The invention is particularly useful in the production of articles having surfaces exposed to human contact where it is desirable to reduce e.g., surface microbes and so reduce transmission of the microbes to a person who contacts the surface. Such surfaces are of course ubiquitous, examples being building hardware such as door handles, furniture, etc.

In a further aspect of the invention, where a polymer is present, the polymer formed as part of the antimicrobial surface includes one or more biocidal agents.

A further understanding of the functional and advantageous aspects of the present invention can be realized by reference to the following detailed description and drawings.

### BRIEF DESCRIPTION OF THE DRAWINGS

Preferred embodiments of the invention will now be described, by way of example only, with reference to the drawings, in which:

FIG. 1 is a schematic cross-section of a wire arc thermal spray gun;

FIG. 2 shows an optical microscope photograph of a cross section of a hardwood maple substrate coated with brass by wire-arc spraying without damaging the wood surface;

FIG. 3A shows the coated samples on planed soft maple that was sanded with 60-grit sandpaper and;

FIG. 3B show the coated samples on the back of the same sample as FIG. 3A that was sanded with 60-grit sandpaper;

FIG. 4 shows adhesion strength of copper coating to different wood species when applied at 8% moisture contents;

FIG. 5 is an image of cohesion loss of MDF samples after pull-off adhesion tests;

FIG. 6A shows the non -uniform distribution of copper coating on earlywood areas of oak samples and;

FIG. 6B cell structure of oak;

FIG. 7 is a BSE image of cross-section of Cu-coated mahogany wood samples;

FIG. 8 shows photographs of decay test jars of uncoated and bronze coated pine after 60 days in fungi environment (Gloeophyllium);

FIG. 9A shows photographs of samples in the mold exposure chamber and;

FIG. 9B MDF coated samples after 6 weeks of test;

FIG. 10 shows an SEM of a sanded brass coating with cavities filled by a lacquer (white spots);

FIG. 11A shows bacterial lethality of brass sheet metal and phosphor bronze-MDF. E. coli, gram-negative bacteria. FIG. 11B S. epidermidis, gram-positive bacteria. No statistical difference is observed between brass sheet metal, unsanded (bronze) and sanded (bronze sanded) phosphor bronze-MDF in panels A and B FIGS. 11A and 11B. Statistical difference is observed between steel and bronze sanded (p-value=0.027) in panel A. In panel B, steel and bronze are statistically different (p-value=0.038);

FIG. 12A-12F shows an evaluation of the biocidal efficacy of a phosphor bronze-MDF substrate. Representative epifluorescence microscopy images of E. coli incubated for 2 hours on unsanded (FIGS. 12A-C) and sanded (FIGS. 12D-F) phosphorus-bronze-MDF. (A & D, Syto9®; B & E, propidium iodide; C & F; merged images of FIG. 12A & FIG. 12B and FIG. 12D & FIG. 12E respectively).

FIG. 13A-13F shows an SEM analysis of surface topographies. (FIG. 13A and FIG. 13D) Brass sheet metal, (FIG. 13B and FIG. 13E) unsanded phosphor bronze-MDF, (FIG. 13C and FIG. 13F) sanded phosphor bronze-MDF. (FIGS. 13A-C) Scanning electron photomicrographs. (FIGS. 13D-F) The scale bars in panels A, B and C (FIGS. 13A-C) are 300, 200 and 200 μm respectively. The scale bar for panel C is not shown, but is the same as for panel B.

FIG. 14 is a photograph showing handles of a hospital operating light coated in accordance with the invention;

FIG. 15 is a photograph showing handles of a hospital wheel chair coated in accordance with the invention;

FIG. 16 is a bar graph showing mean CFU/cm² counted for chairs having coated arms and (n=16) and controls (n=16) taken on day 1 and day 2, visually identified outliers having been removed. Day 2 measurements were taken about 24 hours after day 1 measurements, the arms having been cleaned using commercially available hydrogen peroxide wipes after sampling on day 1; and

FIG. 17 is a bar graph showing the median numbers of colonies on treated and untreated chair arms on days 1 and 2.

### DETAILED DESCRIPTION OF THE INVENTION

Without limitation, the majority of the systems described herein are directed to a thermal spray system. As required, embodiments of the present invention are disclosed herein. However, the disclosed embodiments are merely exemplary, and it should be understood that the invention may be embodied in many various and alternative forms.

The figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to a thermal spray system.

As used herein, the term “about”, when used in conjunction with ranges of dimensions, velocities, temperatures or other physical properties or characteristics is meant to cover slight variations that may exist in the upper and lower limits of the ranges of dimensions as to not exclude embodiments where on average most of the dimensions are satisfied but where statistically dimensions may exist outside this region. For example, in embodiments of the present invention dimensions of components of a thermal spray system are given but it will be understood that these are non-limiting.

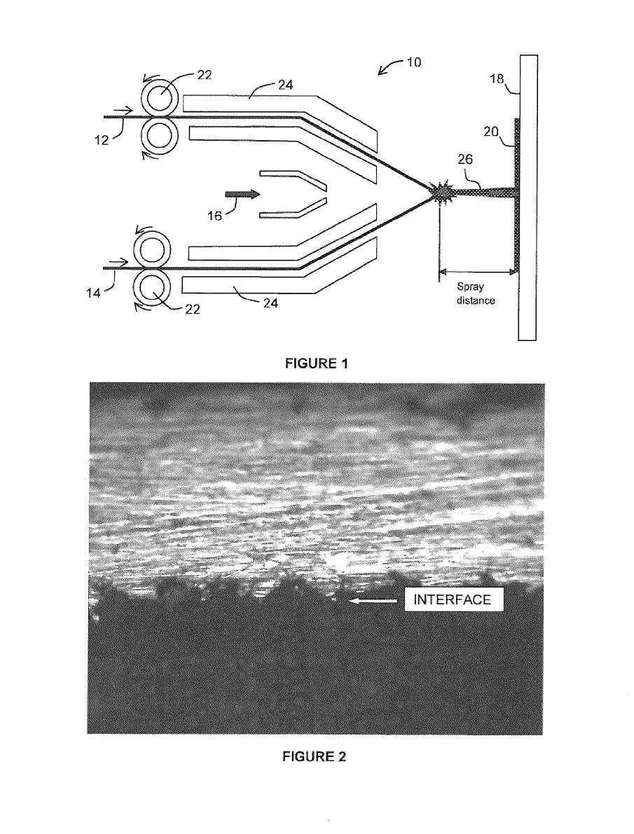

In a preferred embodiment of the present invention, metal is deposited onto a substrate via an electric arc wire spray process. A functional schematic of the process is shown in FIG. 1 which illustrates a wire arc spray gun generally at 10. During the coating process, a large voltage is applied between two metallic wires 12 and 14 such that high currents flow between the wires.

Compressed air 16 atomizes the molten material and accelerates the metal into a jet 26 which contacts substrate 18 to form a coating 20. The wires are fed using rollers 22 and guided by wire guides 24. The wires may be of any metal; non-limiting examples include bronze, copper, aluminum, or stainless steel.

It will be appreciated by those skilled in the art that many other methods of deposition may be used and it is understood that the present invention is not restricted to the use of the wire arc spray process to deposit the metal layers, although it is cost effective and robust process and thus is a preferred embodiment. Other types of thermal spray such as flame spray, plasma spray, high-velocity oxygen-fuel spray, kinetic or cold spray, may be used in place of the wire arc spray gun 10 of FIG. 1.

In the case of a heat sensitive substrate such as wood, the thermal spraying process is configured to pass a relatively low heat load to the substrate. In such context, this feature is important as it allows one to spray metal coatings on heat sensitive materials such as solid organic substrates e.g., wood or wood composites. To protect wood substrates from decomposition, it is preferable that the incoming metal plume spray is at the lowest temperature possible. At the point of impact between the jet 26 and substrate 18, the metal particles should be molten but still have a temperature close to the melting point of the metal.

Accordingly, the particle temperature may be measured optically by two-color pyrometry to determine an optimal spray distance depending on melting point of the sprayed metal. Among systems for in-flight particle temperature measurements available on the market, DPV-2000 and Accuraspray are well-established systems manufactured by TECNAR Automation Ltd., St-Bruno, Qc, Canada (6).

Prior to applying the coating onto a surface of a substrate, in-flight particle conditions such as temperature, velocity, size and number of particles are measured for the particular metal being deposited along the centerline of the particulate plume by a sensor at various spray distances. Since particles in-flight are cooled by ambient air, substantially all particles will solidify after travelling a certain distance.

Based on these measurements one can determine at what distance from the surface of the substrate 18 being coated the particles temperature is close to its melting point but are not yet solidified and are still in a molten phase. As a result, a set of spray parameters such as spray distance and torch input power for specific metallic materials is established. This set of parameters will allow the deposition of metal coatings with minimal damage to wood substrate.

Based on the authors tests and data available in literature the optimal spray distance for stainless steel was established in a range from about 350 to about 400 mm. For copper and its alloys the distance was from about 270 to 300 mm. The spray distance is defined as a distance from nozzle or tip of the spray gun to the substrate.

In order to reduce damage to a heat sensitive substrate, the metal coating is preferably rapidly cooled down immediately after it is deposited. The temperature should be reduced from the melting point of the metal to a temperature safe for the substrate, typically below about 150° C. This cooling can be provided, for example, by air jets directed to the spray area. The air flow rate will depend on several parameters including the distance of the air nozzle from the substrate surface, nozzle diameter, deposition rate and metal thermal properties. For instance, inventor calculations show that for an air jet with a 25 mm diameter placed at a distance of 50 mm from the surface when the spraying rate is approximately 54 g/min, the air flow should be somewhere between 50 to 250 l/min. The higher the flow rate, the more effective the cooling of the substrate will be.

Metal bonds to organic substrates in different ways depending on the nature of the substrate. The choice of substrate has an effect on the coating procedure. In a preferred embodiment of the present invention, the substrate is a hardwood. Microscopic observations show that hardwoods have specialized structures called vessels for conducting sap vertically, which on the end grain appear as pores. Therefore, hardwoods are referred to as porous woods in contrast to nonporous softwoods in which the sap is transferred vertically only through cells called tracheids. The pores of hardwoods vary considerably in size, being visible without a magnifying glass in some species but not in others (7).

The surface morphology of hardwoods allows deposition of metal coating without any surface conditioning like grit blasting or cutting grooves as it was required in prior art [4,5]. Using a hardwood maple substrate and proper spray distance it was possible to deposit well adhered brass coating by wire-arc spraying without damaging the wood surface. The sample was cut polished and the coating-substrate interface was photographed under optical microscope (FIG. 2). The interface shows that the coating penetrates into substrate grains/roughness providing good adhesion.

The type of organic substrates that can be coated using the method disclosed herein include hardwoods with a fine porous wood interface such as mahogany, oak, ash, hard maple, birch or beech. The choice of wood may depend on the amount interface desired. Mahogany, Oak, and Ash have a very porous surface which would give the greatest mechanical bond. Hard Maple, Beech and other smaller grain hardwoods the least interface. The wood selection would depend on the end use.

Moisture content of hard wood substrates should be controlled by Kiln drying according to industry standards to ensure a good mechanical bond.

Any woods with high resin content such as soft woods (pine, fur etc) should be avoided, because the nature of these woods will compromise the adhesion of the metal layer to the wood surface.

In addition to the temperature of the droplets as they hit the substrate surface, studies by the inventors have shown that particle velocity is also an important parameter. The inventors studies of the wire-arc process show that the metal particles acceleration continues to distances 170-200 mm depending on the process parameters, primarily on atomising gas flow rate and the metal density. At longer spray distances for organic substrates particle velocities may be adjusted by increasing of atomizing gas flow rate or using spray guns which provide higher particle velocities.

A variety of studies, described below, have been carried out to examine characteristics of products obtained using methods of the invention, which can aid in optimizing parameters to obtain a coated substrate suitable for its intended use.

### Adhesion

Five copper coated wood species and MDF were compared the adhesion of the copper coating examined for different substrate moisture content.

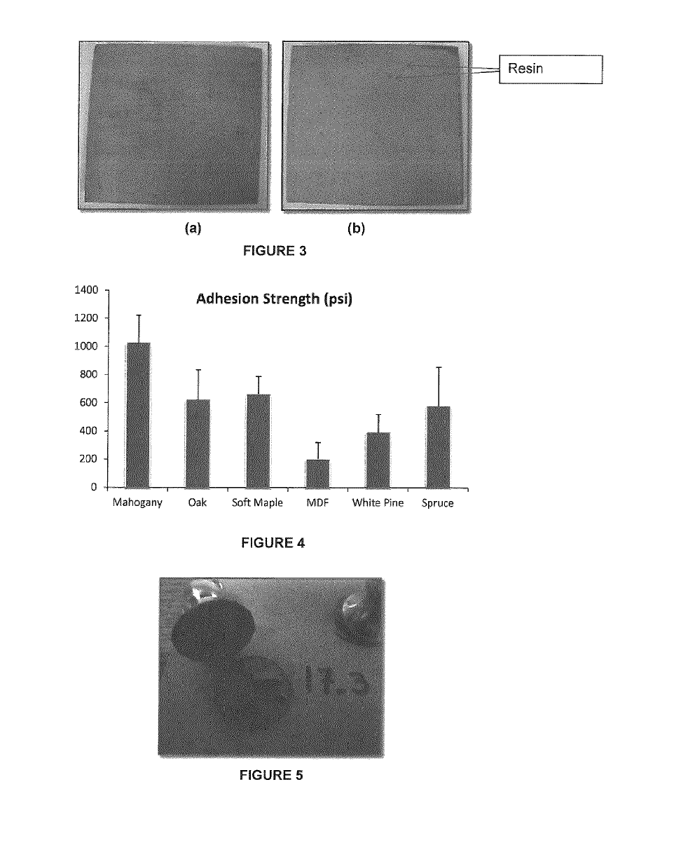

It was found that sanding the wood surfaces, especially softwoods, with 60 grit sandpaper improved the adhesion of copper coating to wood, presumably by creating more sites for mechanical interlocking and results in uniform coatings layer on the wood surfaces. FIG. 3 shows a coated sample that had a planed wood surface and the backside of the same sample when sanded with 60 grit sandpaper prior to application of the copper coating.

As can be seen in FIG. 3, resin bleeding of coated wood samples was observed. This issue can be addressed by e.g., kiln drying of a sample, or washing the surface with turpentine solution prior to applying the metal coating. Washing with turpentine solution was found to reduce resin bleeding in the coated product, especially for spruce wood samples.

The adhesion strength of coating to wood samples was measured by Pull-off test, based on ASTM D4541 using 20 mm Dollies, FIG. 4 summarizes the results obtained using different wood species when coated at average moisture content of about 8%. Outlier data were not considered in the average calculations, which are based on nine measurements.

The adhesion of copper to MDF was found to be particularly strong, but the results shown in the graph of FIG. 4 are low because of the weak cohesion between MDF layers i.e, weakness in the substrate. In all cases, copper coated layer were attached to a thick layer of MDF as can be seen in FIG. 5.

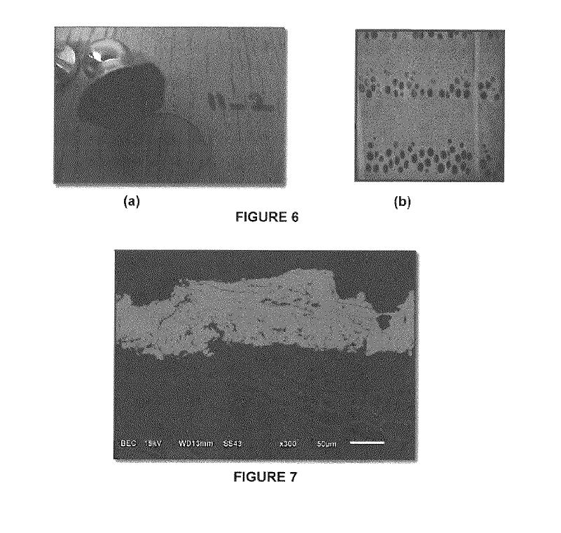

Generally, metal adhesion was found to be better for hardwood samples than softwoods. The copper coating to mahogany was found to be the best; and this could be due to its relatively uniform structure as a diffuse-porous wood and creating good mechanical interlocking. Soft maple also had a more uniform coating layer than oak. FIG. 6 shows the delamination of earlywood after the adhesion test, non-uniform coating layer on the top surface, and the cell structure of oak wood sample. Both adhesion of copper and cohesion of wood components were poor in earlywood section of oak samples which could be because of the large vessels structure of oak FIG. 6(b).

Adhesion of samples was found to decrease significantly when copper coating was applied on wood samples conditioned at a moisture content of 22%. This might be due to evaporation of excess water during the thermal spray application of hot metal and creation of an isolation layer on the wood surface.

### SEM Analysis

A cross section of mahogany coated wood samples were embedded in epoxy resin and polished with 10μ diamond paste then gold coated. Since copper has higher atomic mass than wood there is a clear contrast between the coating layer and wood in the back-scattered electron (BSE) mode of scanning electron microscopic (SEM) analysis. BSE image of sample were obtained at different magnifications. FIG. 7 is an image of embedded samples at 300×; good adhesion is apparent in most areas, there being a small area where the wood layer is broken close to wood surface. This may be the effect of the saw during cutting the cross sections.

### Decay Test

Durability performance of copper coated samples was examined based on AWPA E10-06 standard by placing two samples one coated and one uncoated in a jar. Three different fungi: Gloeophyllum trabeum (GT), Postia placenta (PP), Trametes versicolor were inoculated in potato dextrose agar. Fifteen test jars were prepared by adding 180 g of soil, 50 g of distilled water, and two feeder strips. The jars were then sterilized at 110° C. for 50 minutes. Five replicate jars were inoculated with each species of fungi and placed in an incubator at 25° C. and 70% relative humidity for two weeks before adding the test blocks. Five replicate samples of copper coated and uncoated wood samples of 19 mm blocks were prepared, weighed, autoclaved, and placed in soil jars on the infected feeder strips. The jars were placed in a dark cabinet at 20° C. and 65% relative humidity for one month. As can be seen in FIG. 8, sample number 3, a replicate representing sample prepared inoculated by Gloeophyllium fungi did not display much growth. This may have been due to inactivity of the fungus.

### Mold Test

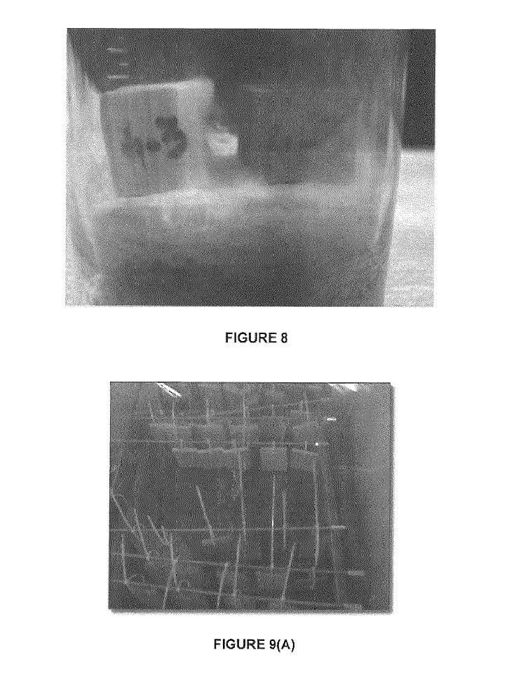

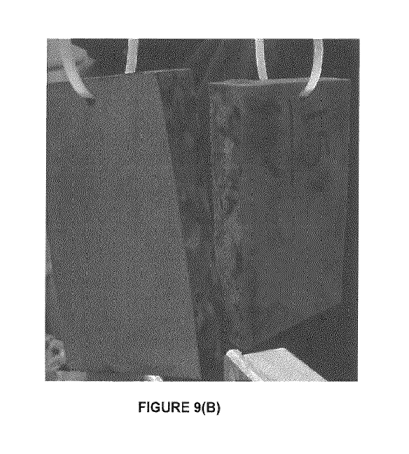

The resistance of copper-coated surfaces to mold growth were assessed based on AWPA E24-06 standard test methods. The top surface of three replicate samples of mahogany, oak, soft maple, white pine and MDF (12 cm×7 cm×2 cm) were copper coated. The coated samples were hung in the conditioning chamber at 32° C. and 95% relative humidity about 7 cm above the wet soil inoculated with four mold species: 1—Aureobasidium pullulans, 2) Aspergillus niger v. Tiegh, 3) Penicillium citrinum Thom and 4) Alternaria tenuissima group. FIG. 9 shows the samples after 6 weeks exposure. FIG. 9(b) shows an MDF sample that is swollen almost to its double size (thickness) and heavy mold growth is evident on the uncoated sides. However, the copper-coated surface was free of mold.

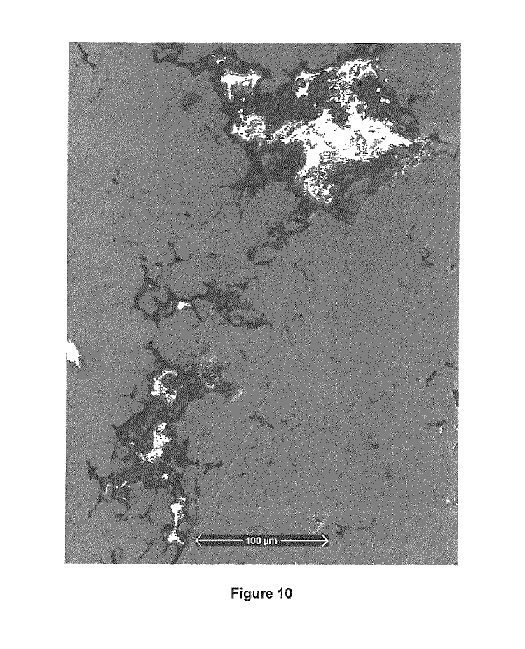

An SEM of a sanded brass coating with cavities filled by a lacquer (white spots) is shown in FIG. 10.

The process disclosed herein is not restricted to depositing one layer of metal. Different types of metals may be applied, in successive layers. In a preferred embodiment, the layer closest to the surface of the substrate 18 has a low melting point, and successive layers have higher melting points. This ensures that the substrate surface is not damaged by high temperatures, and that the outer layers are more resilient. Non-limiting examples of metals that may be used include copper and its alloys e.g., alloys that contain nickel, or silver, or both nickel and silver, bronze, brass, etc., silver and its alloys, zinc, tin, and combinations thereof. A particular copper alloy is one which is copper-nickel-silver that is between about 55 to about 75% copper, or between about 60% and 70%, or between about 65% and 70%, or about 60%, about 61%, about 62%, about 63%, about 64%, about 65%, about 66%, about 67%, about 68%, about 69%, about 70% or about 71% copper.

The coatings may have thickness between about 100 and about 400 micrometers depending on the purpose of the coating (protective or decorative), the environment in which the coated article will be located (interior, exterior, cold, warm etc.) but it will be appreciated the thickness of the final coating(s) is not restricted to this range. Possible thickness can thus be in the range, for example, of 100 to 350 μm, 100 to 300 μm, 100 to 250 μm, 200 to 350 μm, 100 to 300 μm, 100 to 250 μm, 100 to 200 μm, 150 to 350 μm, 150 to 300 μm, 200 to 500 μm, 200 to 450 μm, 200 to 400 μm, 250 to 600 μm, 250 to 500 μm, 250 to 500 μm, 250 to 450 μm, 250 to 400 μm, 250 to 350 μm, etc. Average thickness can be e.g., about 100, 150, 200, 250, 300, 350 or 400 μm.

Subsequent to coating with metal, the surface of the metal-coated substrate is optionally subject to post-treatment coating with a sealant or other suitable composition that forms a film on the metal surface. A sealant can act to seal inherited porosity of thermally sprayed coatings to provide longer protection for the organic substrate. A sealant could be a low viscosity polymer solution from but not limited to polymers such as phenolic, epoxy, urethane, silicone, alkyd, polyvinyl fluoride or acrylic.

More particularly, acrylic coatings are available in air drying or thermosetting compositions, acrylics are relatively high cost materials. Epoxy coatings have excellent resistance to wear and chemicals. They are relatively expensive and are only available in thermosetting or two part (catalyst activated) compositions with relatively short pot lives. They are good for severe indoor applications, but can degrade rapidly and darken in a few months of exterior service.

Silicone coatings provide the best potential for coatings which must operate at elevated temperatures. Ultraviolet absorbing compounds can be added to prevent darkening of the silicone during exterior exposures.

Alkyd coatings are slow drying and baking is required when applying the alkyd coatings.

Urethane coatings may be used but color degradation on exterior exposure has been a problem with urethane coatings.

Polyvinyl fluoride films (Tediars) may be applied by roll bonding with an adhesive. Tedlar films have been used to protect sheet copper in exterior applications.

The surface bearing the polymeric film is subsequently mechanically treated to remove portions of the polymeric film. This exposes the underlying metal to create an exposed metal surface. Portions of the film that have formed within depressions or cavities in the metal surface remain as part of the substrate coating.

Advantageously, a finished surface, whether or not it includes an organic polymer film coating, having an overall Rₐ between 0.2 and 6 or 6.0 μm roughness is produced by the mechanical treatment step. A preferred mechanical treatment involves abrading the film-coated metal by abrasives bonded to a substrate (emery cloth, grinding discs etc) or abrasive slurries, pastes, suspensions, etc.

It is possible for a finished surface to have an overall roughness, Rₐ, of 0.2, 0.3, 0.4, 0.6, 0.8, 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8 or 6.0 μm, or to be within any range defined by any of these values selected as endpoints, such ranges thus being disclosed here, even if not explicitly set out. For example, the range of Rₐ between 0.2 and 4.4 is considered to be disclosed by the foregoing.

The abrading step can thus also be conducted to produce a surface having an Rₐ, in the range of 0.2 to 10 μm, 0.4 to 10 μm, 0.2 to 10 μm, 0.6 to 10 μm, 0.8 to 10 μm, 1 to 10 μm, 1.5 to 10 μm, 2 to 10 μm, 3 to 10 μm, 0.4 to 8 μm, 0.4 to 7 μm, 0.4 to 6 μm, 0.4 to 8 μm, 0.6 to 8 μm, 0.6 to 7 μm, 0.6 to 6 μm, 1 to 8 μm, 1 to 7 μm, 1 to 6 μm, 1.5 to 8 μm, 1.5 to 7 μm, 1.5 to 6 μm, 2 to 8 μm, 2 to 7 μm, 2 to 6 μm, 2 to 5 μm, 3 to 10 μm, 3 to 9 μm, 3 to 8 μm, 3 to 7 μm, or 3 to 6 μm.

Where the surface of the outer thermally sprayed metal coat has an initial roughness, Rₐ¹, mechanical abrading is conducted to produce a surface having Rₐ² where Rₐ² <Rₐ¹. In embodiments, it is possible that Rₐ¹>20Rₐ², R^{a}¹>18Rₐ², Ra¹>16Rₐ², Rₐ¹>14Rₐ², Rₐ¹>12Rₐ², Rₐ¹>10Rₐ², Rₐ¹>9Rₐ², Rₐ¹>8Rₐ², Rₐ¹>7Rₐ², Rₐ¹>6Rₐ², Rₐ¹>5Rₐ², Rₐ¹>4Rₐ², Rₐ¹>3Rₐ², Rₐ¹>2Rₐ².

The abraded surface preferably has a roughness, Rₐ², that is no greater than 6 μm and (Rₐ¹−2)>Rₐ². In embodiments (Rₐ¹−2)>Rₐ², (Rₐ¹−3)>Rₐ², (Rₐ¹−4)>Rₐ², (Rₐ¹−5)>Rₐ², (Rₐ¹−6)>Ra², (Ra¹−7)>Rₐ², (Rₐ¹−8)>Rₐ², (Rₐ¹−9)>Ra², (Ra¹−10)>Ra², (Rₐ¹−11)>Rₐ², (Rₐ¹−12)>Rₐ², (Rₐ¹−13)>Rₐ², (Rₐ¹−14)>Rₐ², depending to some degree on the roughness of the surface (Rₐ¹) prior to abrading, which can be for example, in the neighborhood of 9, 10, 11, 12, 13, 14, 15, or 16 or higher, and the desired surface roughness of the finished product.

It is also preferred that the profile valley depth, Rᵥ, of the surface be reduced by the abrading e.g., the surface of the outer thermally sprayed metal coat has Rᵥ¹ and the surface produced by abrading has Rᵥ², and Rᵥ² <Rᵥ¹. It is particularly preferred that Rᵥ²/Rᵥ¹≦0.8 or 0.7 or 0.6 or 0.5 or 0.4 or 0.3 or 0.2 or 0.1.

The value of Rᵥ² is preferred to be less than or equal to 40 μm, more preferably ≦35 μm, ≦30 μm, ≦25 μm or even ≦20 μm.

As mentioned above, a polymeric film can be formed having one or more biocidal agents embedded therein. Many such agents are known. In embodiments, one or more biocidal agents are selected from the group consisting of silver ions, copper ions, iron ions, zinc ions, bismuth ions, gold ions, aluminum ions, nanoparticles of heavy metals and oxides such as silver, copper, zinc, metal oxides, metal oxide-halogen adducts such as chlorine or bromine adducts of magnesium oxide, quaternary ammonium compounds such as 2,4,4′-trichloro-2′-hydroxydiphenyl ether, chlorhexidine, triclosan, hydroxyapatite, gentamicin, cephalothin, carbenicillin, amoxicillin, cefamandol, tobramycin, vancomycin, antiviral agents such as quaternary ammonium salts e.g. N,N-dodecyl,methyl-polyethylenimine, antimicrobial peptides. Possible antimicrobials include those listed in US 2012/0070609 (8) published Mar. 22, 2012: tea tree oil, parabens, paraben salts, allylamines, echinocandins, polyene antimycotics, azoles, isothiazolinones, imidazolium, sodium silicates, sodium carbonate, sodium bicarbonate, potassium iodide, sulfur, grapefruit seed extract, lemon myrtle, olive leaf extract, patchouli, citronella oil, orange oil, pau d'arco and neem oil. Particular parabens include methyl, ethyl, butyl, isobutyl, isopropyl and benzyl paraben and salts thereof. Particular azoles include imidazoles, triazoles, thiazoles and benzimidazoles.

A metalized substrate surface is usually selected for its antimicrobial properties. Such metals include a metal or alloy selected from: copper, silver, zinc.

### Antimicrobial Activity

A series of experiments have been performed to establish the feasibility of coated surfaces disclosed here.

### Materials and Methods

### Copper Alloys

Phosphor bronze was selected as the coating material due its high copper content (91.7% copper, 7.5% tin, 0.8% phosphorus) to ensure antimicrobial properties. The coating was deposited onto medium density fiberboard (MDF). The coating surface was abraded by sanding to reduce Rₐ from an initial value (as deposited) of about 12.85 μm to about 4.3 μm after sanding. The maximum profile valley depth (Rᵥ) also was reduced from an initial value of about 47 μm to about 22 μm. Brass sheet metal (manufactured by PMX) with a regular striated pattern from machining and having a lower surface roughness than the thermal sprayed alloys was also tested, along with a stainless 304L steel control. The molecular composition of the copper alloys was determined by EDS (Quantax 70 from Bruker Nano GmbH). The composition of the bronze sheet was determined to be 87% copper and 13% zinc. Surface topography measurements were performed with a diamond stylus profilometer (Surfometer 400, Precision Devices, Milan, Mich.). All 3D surface images were obtained by merging four ESM images taken at different angles using 3D-Image Viewer (Denshi Kougaky Kenkyusyo Co.)

### Bacterial Strains Growth Conditions and Live/Dead Staining

Inoculations were prepared by suspending a bacterial colony in 10 ml of sterile LB broth that was kept on a rotary shaker for 24 hours at 37° C. Bacteria were then regrown for 3 hours on fresh sterile LB broth until log phase. The bacteria were added onto the substrates in order to allow for culture for 2 hours. After 2 hours, the samples were washed with 10 mL sterile PBS and plated on agar plates at 37° C. overnight. The colonies were used to quantify bacterial cells that survived on the coatings.

E. coli or S. Epidermidis were incubated for 2 hours at room temperature. Substrates were stained with LIVE/DEAD Baclight viability kit (Invitrogen). SYTO 9, a green fluorescent nucleic acid stain and propidium iodide (PI), a red fluorescent nucleic acid stains were used for determination of viable bacteria. When SYTO 9 was used independently it was possible to label all the bacteria due to cell permeable properties shared by the two dyes. Propidium iodide is not cell permeable and hence is only able to stain cells where the membrane has been disrupted indicating nonviable cells. The co-stain was prepared by mixing 30 μl of SYTO 9 and 30 μl of propidium iodide, diluting this solution to 1/200 in distilled water. 6 μl of the dye was poured on each substrate where the bacteria were inoculated. The staining was kept in the dark for 15 minutes. Substrates were then rinsed with distilled water. The fluorescent bacteria were visualized using fluorescence with Zeiss SteREO Discovery. V20

[symbol]

Bacterial counts were performed by counting individual fluorescent spots within three random fields of view per sample at 120× magnification. SEM analysis revealed that a fluorescence spot 9.5 μm² wasrepresentative of one bacterium, making it feasible to count individual cells. Large, irregular shape fluorescence stains were not counted. Dividing propidium iodide red fluorescence by SYTO 9 green fluorescence staining of individual bacteria quantitated lethality.

### Analysis of Bacterial Morphology

After inoculation for 2 hours on the copper surface, bacterial cells were fixed using 4% of formaldehyde in PBS buffer. Fixation was kept overnight at 4° C. under rotating motion. Samples were then washed with PBS three times. The samples were then post fixed using 1% osmium tetroxide for 1 hour at room temperature. The osmium tetroxide was then washed off with 0.1 M PBS buffer three times for five minutes. The samples were then dehydrated in 50%, 70%, 80%, 90% and 100% ethanol for 5 minutes, 10 minutes, 10 minutes, 15 minutes, and 2×10 minutes respectively. Chemical critical point drying was achieved using hexamethyldisilizane series (HMDS) at 3:1, 1:1, and 1:3 parts ethanol to HMDS. Each treatment was kept for 30 minutes and two changes of 100 HMDS were used for 15 minutes. The last change of HMDS was left to volatilize overnight in sterile petri dish.

For SEM observations (Hitachi S2500), samples were then sputter coated with gold-palladium.

The statistical program Graphpad® Prism was used to calculate significant difference among results. The Kruskal-Wallis test was used with a Dunn modification testing for multiple sample comparisons.

### Results

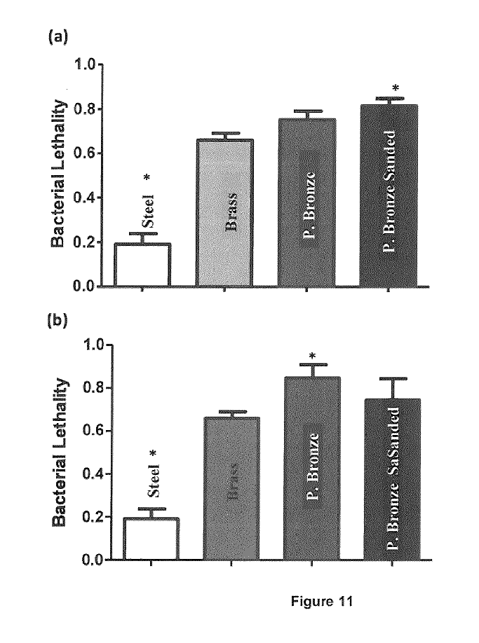

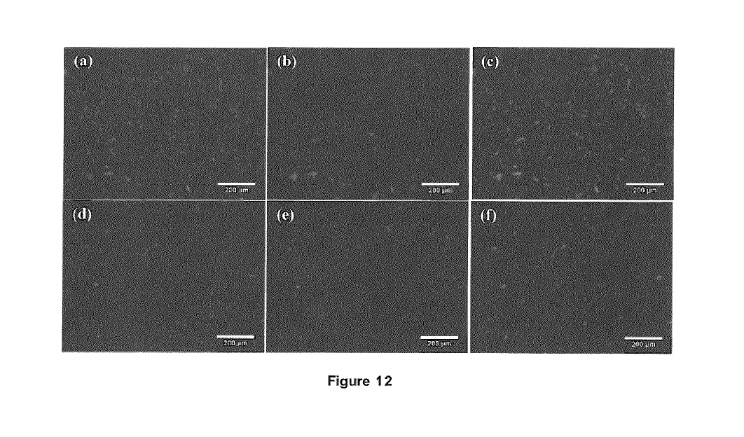

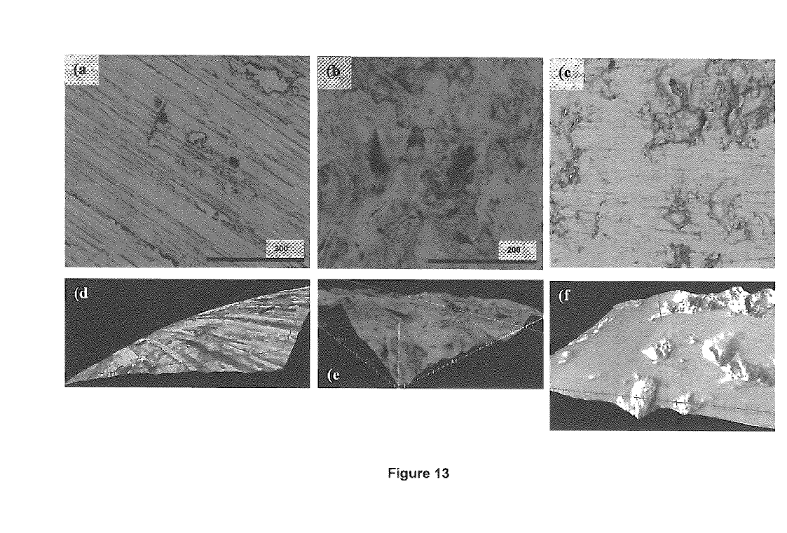

A standard viable, plate count method was initially used to quantitate the biocidal efficacy of all surfaces. Approximately 5000 gram-negative E. coli and gram-positive S. epidermidis bacteria in PBS buffer were plated onto 2 cm² surfaces. Quantitative evaluation of the biocidal efficacy revealed that greater than 80% of the E. coli and S. epidermis were killed by exposure to brass sheet metal, compared to less than 20% with stainless steel (data not shown). However, no live cells were observed on LB agar plates for either of the phosphor bronze coatings. As it seemed improbable that the phosphor bronze coatings, with a similar copper content as the brass sheet metal, would result in a 100% cell death, quantitative evaluation of biocidal activity was performed by the direct observation of bacteria on the surfaces by epifluorescence microscopy using SYTO 9 and propidium iodide stains. Data obtained indicate that a lethality ratio of 0.19 for E. coli and S. epidermidis was observed after a two-hour exposure to control stainless steel. By comparison, E. coli lethality ratios of 0.66, 0.75 and 0.81 were observed for brass sheet metal and unsanded and sanded coating surfaces, respectively. Lethality ratios of 0.68, 0.85 and 0.74 for S. epidermidis were observed on brass sheet metal and on unsanded and sanded coatings, indicating comparable biocidal efficacies by the different copper alloy surfaces for gram-negative and gram-positive bacteria. Statistically significant differences in lethality were observed between stainless steel and the copper containing alloys (FIG. 11). Representative epifluorescence images of E. coli bacteria on the unsanded and sanded coatings are shown in FIG. 12, highlighting the fraction of cells with compromised membranes (red, panels b and c) vs total (green, panels a and d) observed at 120× magnification. The yellow fluorescence seen in the merged images (panels c and f) indicate the majority of bacteria were killed. Similar images were obtained for S. epidermidis co-stained with SYTO 9 and propidium iodide after exposure to stainless steel and brass sheet metal (data not shown). Surface topography plays a role in the adherence of microbes to their substrates. To determine differences between the bacterial adhesions to the sheet metals compared with the coating, surface topography was analyzed. Rₐ measurements revealed that surface roughness ranged from 0.18, 0.54, 12.85, and 4.3 μm for stainless steel, brass sheet metal, unsanded and sanded phosphor bronze coating, respectively. Consistent with the large range in Rₐ values, scanning electron microscopy revealed a relatively smooth, striated surface for brass sheet metal (FIG. 13a) compared to the highly variable topographical appearance of unsanded (FIG. 13b) and sanded (FIG. 13c) coatings. Three-dimensional analysis of the SEM images highlighted the different degrees of surface roughness between brass sheet metal (FIG. 13d) and the unsanded coating (FIG. 13e). Sanding of the coating reduced roughness by removing the peaks, leaving valleys intact (FIG. 13f).

Bacteria that were not released from the phosphor bronze coating were further investigated using SEM to examine the morphology of the cells after a two-hour incubation. The majority of E. coli on the control stainless steel were rod-shaped with smooth surfaces. Similarly, the surfaces of the spherical S. epidermidis appeared smooth, indicating that control stainless steel had no significant impact on the morphology of gram-negative and gram-positive bacteria. In contrast, the surface morphology of E. coli and S. epidermidis was slightly more irregular when exposed to the brass sheet metal. While there was no significant difference in biocidal activity between brass sheet metal and the unsanded or sanded phosphor bronze coatings (FIG. 11), there was a dramatic increase of the surface roughness and a 3 to 4 fold increase in the size of E. coli exposed to the coatings with a minor subset lysed.

### Discussion

Several studies have demonstrated that exposure of bacteria to copper alloys (>60% copper) for two hours at 37° C. results in the killing of approximately 90% of the bacteria (1). Consistent with the inverse relationship between biocidal activity and copper content, these results indicate that 80% of the gram-negative E. coli and gram-positive S. epidermidis were killed when exposed for two hours at room temperature to brass sheet metal with 87% copper content. The biocidal efficacy was increased by 10 to 15% when cells were exposed to phosphor bronze coatings with slightly higher copper content of 91.7%. Unexpectedly, in contrast to control stainless steel and brass sheet metals, neither viable E. coli nor S. epidermidis were released from sanded and unsanded coatings despite rigorous washing in the presence of glass beads, which could have been attributed to different surface roughness. Analysis by epifluorescence microscopy revealed that the biocidal activity of brass sheet metal and the phosphor bronze coating had comparable biocidal activities despite the differences in surface roughness. Hence, the differential cell adhesion between brass sheet metal and phosphor bronze coatings was likely due to a number of variables that included changes in surface topography.

Adhesion of bacteria to abiotic surfaces involves a stereotypic series of steps. The first step involves a gravity-mediated association with abiotic surfaces, a process that is accelerated by flagellar movement (9). The second step, adhesion, is promoted by several factors, such as the membrane composition of the bacteria, the presence of fimbriae/pili, the formation biofilm by bacterial aggregates, as well as the surface topography of the substrate. The transition during this second step from “reversible” to “non-reversible” adhesion can be triggered by the formation of biofilm by bacteria that have made contact with a solid substrate (9). Furthermore, analysis of biofilm production by aggregates of the genetically tractable E. coli over abiotic surfaces is partly promoted by flagellated strains (10). However, E. coli DH5α and S. epidermidis, which have no flagella, also tightly adhered to phosphor bronze coating. Additionally, in contrast to the mainly amorphous appearance of extracellular polymeric biofilms observed under SEM that are formed by bacterial colonies (11), petal-like structures were in intimate contact with the swollen E. coli and a subset of S. epidermidis. Increase in biofilm mass is dependent on bacterial proliferation and the continuous recruitment of free-floating bacteria. Hence, the presence of biocidal levels of copper is likely to be refractory to the growth of biofilms. Although it cannot be discounted that biofilm may have formed that was undetectable by SEM, the combined data indicate that biofilm-mediated adhesion is unlikely to have made a significant contribution to the irreversible adhesion of E. coli and S. epidermidis to the phosphor bronze coating.

Although poorly understood, there is a growing body of evidence that sessile bacteria sense and respond to the topography of their microenvironments, promoting or decreasing their surface adhesion depending on the size, morphology and physiochemical properties of the bacteria. However, with respect to nanostructure surfaces, contradictory results have been reported on the impact of surface roughness and the number of bound bacteria. As reviewed by Anselme et al, the contradictory results in bacterial adhesion are due to a combination of differences in the chemistry, wettability and nanotopography of surfaces. To circumvent issues associated with the impact of variances in substrate chemistry, the adhesion of different bacteria was investigated on glass slides with distinctive degrees of surface roughness, but with no measurable differences in surface chemistry (12). Their study demonstrated that E. coli attached readily to the smooth rather than rough glass surfaces. However, binding of the spherical S. aureus was not as affected by changes in surface roughness in the nano scale range. No significant difference in the number of E. coli and S. epidermidis bound to stainless steel with a Rₐ value of 180 nm was observed here. Approximately 50% more bacteria were associated with the brass sheet metal with a Rₐ value of 540 nm than with stainless steel. SEM images revealed that the surface of both bacterial species appeared rougher when exposed to brass sheet metal. The change in membrane morphology, combined with the rougher surface of brass sheet metal, may have resulted in a higher number of bacteria being retained on brass sheet metal compared to stainless steel.

A striking difference in bacterial morphology was observed between the solid metals and the phosphor bronze coatings. This was particularly evident for E. coli cells that were approximately 3 to 4 fold larger with compromised membranes when plated on the sanded and unsanded phosphor bronze coating. The increased swelling in the presence of a hypotonic PBS solution may reflect that the cell walls of the bacteria were compromised by the copper ions. Swelling was observed after only 30 minutes of exposure to the biocidal surface, indicating that aberrant membrane permeability occurred rapidly, leading to osmotic stress due to the influx of water. Whether the cell walls were damaged by the generation of hydroxyl free radicals by Haber-Weiss and Fenton reactions of reduced copper ions remains to be determined. It is also likely that the E. coli genome was also rapidly degraded by the resultant free radicals as demonstrated for E. coli by Espirito Santo et al (3). As noted by Warnes et al (13), PI does not effectively bind to degraded DNA. It is, therefore conceivable that a subset of the E. coli on brass sheet metal and the phosphor bronze coating may not have been stained with PI, leading to an underestimate of biocidal efficacy. Moreover, intact bacteria with degraded DNA would have been non-viable, which may have affected the viable cell count for E. coli incubated on brass sheet metal.

No significant difference in the size of gram-positive S. epidermidis was observed by exposure to all substrates used in this study. Warnes et al, did not observe a change in the size and membrane morphology of gram-positive Enterococcus faecalis and Enterococcus faecium when exposed to copper alloys with a copper content ranging from 60-95%. Bacterial killing was attributed to an inhibition of cellular respiration and DNA degradation by ROS. In contrast to the results described here, with S. epidermidis where viable cells were detectable after 2 hours of exposure to brass sheet metal, no viable E. faecalis and E. faecium cells were observed after a 1-hour exposure to the copper alloys. As the authors hypothesized, it is conceivable that for gram-positive cells the absence of an outer cell wall and periplasmic space facilitates the intracellular penetration of toxic ROS, leading to cell death with minimum impact on cell membrane. These results indicate that a subset of the S. epidermidis had compromised cell membranes when exposed to phosphor bronze coating, probably reflecting species-specific differences in the response of gram-positive cells to toxic levels of copper, or that macro scale differences between peaks and valleys enhances bacterial killing by increasing the concentration of copper within the valleys where the majority of cells were observed. It is interesting to note that a subset of the S. epidermidis with membrane blebs were also associated with nanoflowers in the presence of PBS, indicating the organic material released from the damaged cells promoted the nucleation of organic-copperphosphate crystals.

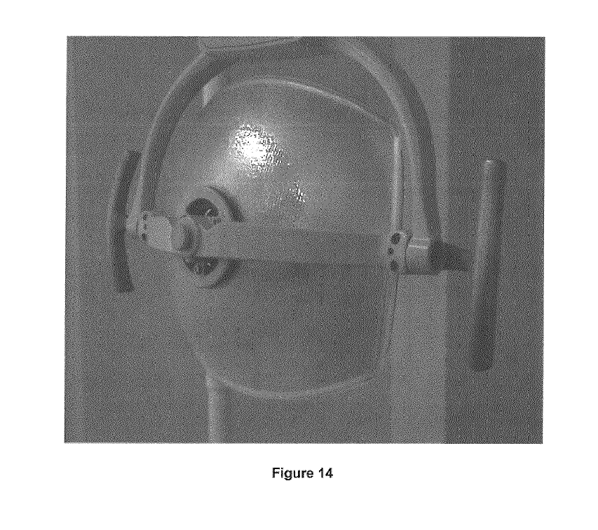

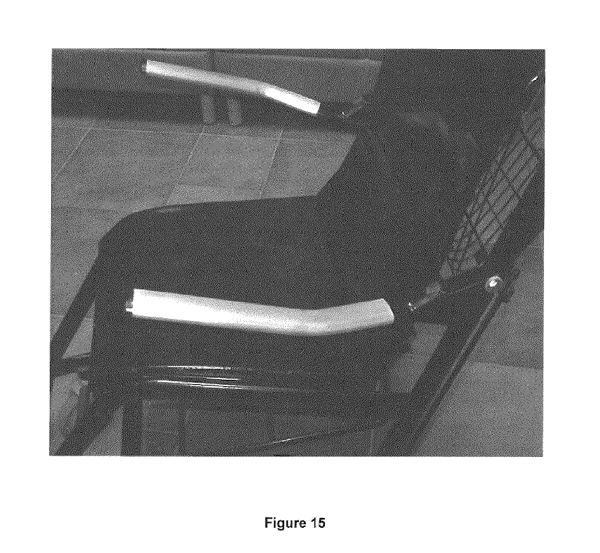

Examples of coated surfaces are shown in FIGS. 14 and 15 which show coated surfaces on the handles of a medical instrument and hospital chair, respectively.

In a preliminary study, the arms of chairs were coated with a with a copper alloy (nickel silver containing 60% copper) material of the invention. Several of the chairs were placed in a waiting room along with an equal number of chairs having plastic arms. The chairs were constructed so as to be as to visually resemble each other. The treated and untreated chairs were numbered and placed randomly in the waiting area.

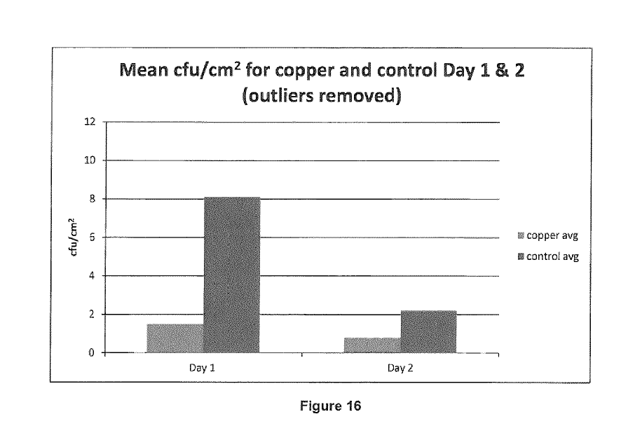

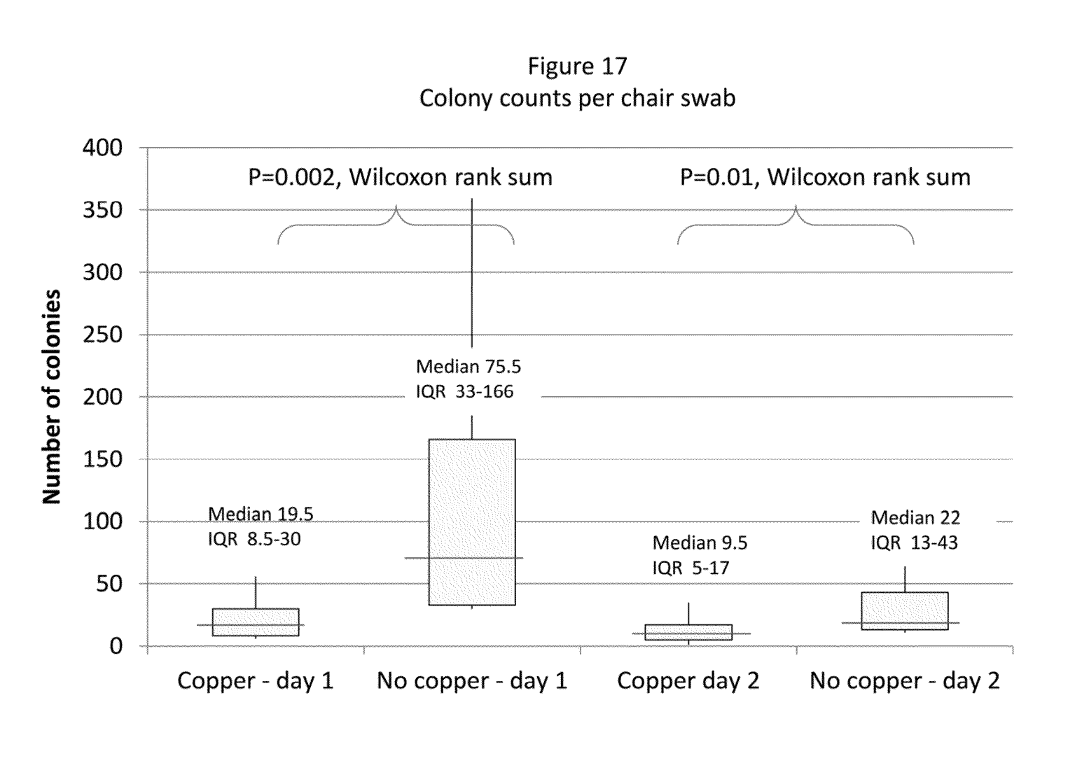

The chairs were swabbed according to a routine protocol by personnel unaware of which chairs were treated and untreated. Swab samples taken from the chair arms were plated on agar using neutralizing broth obtained from BD Diagnostics (Catalogue No. 298318), on which bacterial growth is not inhibited in the presence of copper, and incubated at 35° C. for 18 to 24 hours and CFU counted. A sample of results obtained is presented in FIGS. 16 and 17. The treated chair arms were found to reduce, in comparison to the untreated arms, the numbers of e.g., bacillus, viridians group streptococci, S. Aureus, and Micrococcus luteus.

As used herein, the terms “comprises”, “comprising”, “includes” and “including” are to be construed as being inclusive and open ended, and not exclusive. Specifically, when used in this specification including claims, the terms “comprises”, “comprising”, “includes” and “including” and variations thereof mean the specified features, steps or components are included. These terms are not to be interpreted to exclude the presence of other features, steps or components.

The contents of all references and publications cited herein are incorporated into this specification by reference as though reproduced herein in their entirety.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

### REFERENCES

1. Grass, G., Rensing C., and Solioz M. Metallic copper as an antimicrobial surface. Applied and Environmental Microbiology 2011; 77: 1541-1547
2. Rai S., et al. Evaluation of the antimicrobial properties of copper surfaces in an outpatient infectious disease practice. 2012. The Society for Healthcare Epidemiology of America. 33(2); 200-201.
3. Espirito Santo, C. et al. Contribution of copper ion resistance to survival of Escherichia coli on metallic copper surfaces. Applied and Environmental Microbiology. 2008; 74:977-986
4. Herman H. and Sulit R. 1993. V. 6, Welding, Brazing, and Soldering.
5. U.S. Patent Publication No. 2011/0171396. Pershin V., Portman T., Mostaghimi J., July 14, 2011.
6. Bissons F., Lamontagne M., Moreau C., Pouliot L., Blain J., and Nadeau F., Ensemble In-flight Particle Diagnostics under Thermal Spray Conditions, Thermal Spray 2001: New Surfaces for a New Millennium, C. C. Berndt, K. A. Khor, and E. F. Lugscheider, Ed., May 28-30, 2001 (Singapore), ASM International, 2001, p 705-714.
7. “Structure of Wood.” Research Note FPL-04, Forest Products Laboratory, US Department of Agriculture, March 1980.
8. U.S. Patent Publication No. 2012/0070609. Poppe C., Daly M., Ard K., March 22, 2012.
9. Anselme K., Davidson P., Popa A M., Giazzon M., Liley M., and Ploux L. 2010. The interaction of cells and bacteria with surfaces structured at the nanometre scale. Acta Biomater. 10; 3824-3846.
10. Pratt L. A. and Kolter R. Genetic analysis of Escherichia coli biofilm formation: roles of flagella, motility, chemotaxis and type I pili. 1998. Molecular Microbiology. 30(2):285-93.
11. Flemming H. C and Wingender J. 2010. The biofilm matrix. Nature Reviews Microbiology. 8(9):623-633.
12. Mitik-Dineva N., Wang J., Truong V K., Stoddart P., Malherbe F., Crawford R J., and Ivanova E P. 2009. Escherichia coli, Pseudomonas aeruginosa and Staphylococcus aureus Attachment Patterns on Glass Surfaces with Nanoscale Roughness. Current Microbiology. 58: 268-273.
13. Warnes, S L. Biocidal efficacy of copper alloys against pathogenic enterococci involves degradation of genomic and plasmid DNAs. Applied and Environmental Microbiology 2010; 5390-5401.

1. A method of providing a substrate with an antimicrobial surface, the method comprising mechanically abrading a substrate having an outer thermally sprayed metal coat having surface cavities to reduce the depth of the cavities and produce an exposed abraded metal surface in regions intermediate the cavities.

2. The method of claim 1, wherein the surface of the outer thermally sprayed metal coat has a surface roughness (Rₐ¹) and the surface produced by abrading has a surface roughness (Rₐ²) wherein Rₐ²<Rₐ¹.

3-8. (canceled)

9. The method of claim 2, wherein the surface of the outer thermally sprayed metal coat has Rᵥ¹ and the surface produced by abrading has Rᵥ² wherein Rᵥ²<Rᵥ¹.

10-14. (canceled)

15. The method of claim 9, wherein the metal comprises a metal selected from the group consisting of copper, alloys of copper, silver and its alloys, zinc, tin, stainless steel and any combination thereof.

16. The method of claim 15, further comprising the step of polishing the surface coat subsequent to the step of abrading the coat.

17-20. (canceled)

21. The method of claim 1, the method further comprising providing the substrate having the outer thermally sprayed metal coat having surface cavities by:
a) providing a source of a jet of molten metal particles having an average temperature within a predetermined range, an average velocity within a predetermined range; and
b) directing said jet of molten metal particles at a surface of the substrate thereby depositing a metal coat on the substrate surface, said source being spaced from the substrate a pre-determined distance, and said average velocity and said average temperature being selected for a given metal such that the temperature of the molten metal particles is very close to the melting point of the metal as the molten droplets coat the surface of the substrate.

22. (canceled)

23. The method of claim 15, wherein the metal coat having surface cavities has a thickness between about 100 and about 500 micrometers.

24. (canceled)

25. The method of claim 23 wherein the substrate is an organic substrate selected from wood, wood and polymer composites, and polymer substrates.

26-37. (canceled)

38. The method of claim 23, wherein the metal coat has a polymer film formed thereon, forming the film includes incorporating one or more biocidal agents into the film, and the one or more biocidal agents are selected from the group consisting of silver ions, copper ions, iron ions, zinc ions, bismuth ions, gold ions, aluminum ions, nanoparticles of heavy metals and oxides such as silver, copper, zinc, metal oxides, metal oxide-halogen adducts such as chlorine or bromine adducts of magnesium oxide, quaternary ammonium compounds such as 2,4,4′-trichloro-2′-hydroxydiphenyl ether, chlorhexidine, triclosan, hydroxyapatite, gentamicin, cephalothin, carbenicillin, amoxicillin, cefamandol, tobramycin, vancomycin, antiviral agents such as quaternary ammonium salts e.g. N,N-dodecyl,methyl-polyethylenimine, antimicrobial peptides, tea tree oil, parabens such as methyl-, ethyl-, butyl-, isobutyl-, isopropyl- and benzyl-paraben, and salts thereof, allylamines, echinocandins, polyene antimycotics, azoles such as imidazoles, triazoles, thiazoles and benzimidazoles, isothiazolinones, imidazolium, sodium silicates, sodium carbonate, sodium bicarbonate, potassium iodide, sulfur, grapefruit seed extract, lemon myrtle, olive leaf extract, patchouli, citronella oil, orange oil, pau d'arco and neem oil.

39. The method of claim 1, wherein the surface roughness (Rₐ¹) of the outer thermally sprayed metal coat having surface cavities comprises copper, and is reduced by the step of abrading to produce a surface having roughness (Rₐ²) such that Rₐ²<Rₐ¹ and the reduction is sufficiently small to maintain a roughness such that Rₐ² is in a range which induces swelling in gram negative bacteria exposed thereto in the presence of PBS buffer for a period of two hours.

40-43. (canceled)

44. An article comprising an antimicrobial surface produced by the method of claim 2.

45. An article having an antimicrobial surface, wherein the article comprises a substrate having an overlying metal coat having an exposed metal surface with exposed cavities wherein the surface has surface roughness (Rₐ) of between 1.0 and 10 μm.

46. The article of claim 45, wherein the metal coat is formed directly on and secured directly to the substrate.

47. The article of claim 45, wherein the metal coat is a sprayed metal coat.

48. The article of claim 47, where the exposed metal surface comprises abraded metal portions intermediate said cavities.

49. An article having an antimicrobial surface, wherein the article comprises a substrate having an overlying sprayed metal coat and the surface has exposed cavities wherein portions of the metal are outwardly exposed and walls of the cavities are coated with an organic polymer film.

50-53. (canceled)

54. The article of claim 49, wherein the metal comprises a metal selected from the group consisting of copper, copper alloys, silver and its alloys, zinc, tin, stainless steel, and any combination thereof.

55. (canceled)

56. (canceled)

57. The article of claim 54 wherein the substrate is an organic substrate selected from wood, wood and polymer composites, and polymer substrates.

58-60. (canceled)

61. The article of claim 54, further comprising one or more biocidal agents selected from the group consisting of silver ions, copper ions, iron ions, zinc ions, bismuth ions, gold ions, aluminum ions, nanoparticles of heavy metals and oxides such as silver, copper, zinc, metal oxides, metal oxide-halogen adducts such as chlorine or bromine adducts of magnesium oxide, quaternary ammonium compounds such as 2,4,4′-trichloro-2′-hydroxydiphenyl ether, chlorhexidine, triclosan, hydroxyapatite, gentamicin, cephalothin, carbenicillin, amoxicillin, cefamandol, tobramycin, vancomycin, antiviral agents such as quaternary ammonium salts e.g. N,N-dodecyl,methyl-polyethylenimine, antimicrobial peptides, tea tree oil, parabens such as methyl-, ethyl-, butyl-, isobutyl-, isopropyl- and benzyl-paraben, and salts thereof, allylamines, echinocandins, polyene antimycotics, azoles such as imidazoles, triazoles, thiazoles and benzimidazoles, isothiazolinones, imidazolium, sodium silicates, sodium carbonate, sodium bicarbonate, potassium iodide, sulfur, grapefruit seed extract, lemon myrtle, olive leaf extract, patchouli, citronella oil, orange oil, pau d'arco and neem oil.

62. (canceled)
